(19) United States
(12) Patent Application Publication
(10) Pub. No.: US 2010/0068324 A1
(43) Pub. Date: Mar. 18, 2010

(54) Apparatus for granulating plastic

(75) Inventors: Stefan Pirker, Leonding (AT); Philipp Gittler, Wien (AT)

Correspondence Address: COLLARD & ROE, P.C., 1077 NORTHERN BOULEVARD, ROSLYN, NY, 11576, US

(73) Assignee: ECON GmbH

(21) Appl. No.: 12/584,950

(22) Filed: Sep. 15, 2009

(30) Foreign Application Priority Data
Sep. 18, 2008 (AT) A 1450/2008

(51) Int. Cl. B28B 11/16

(52) U.S. Cl. 425/302.1

(57) ABSTRACT

An apparatus for granulating plastic is described, comprising a granulating head having a die plate (2) for allowing the output of strands of plastic and a rotor (5) which is coaxial to the die plate (2) and comprises granulator blades (4) for cutting strands of plastic exiting from the die plate (2), and a housing (1) for the granulating head which is connected to a discharge line (11) and a feed line (10) via a feed chamber (8) for a conveying and cooling medium receiving the granulate, preferably a cooling fluid. In order to provide advantageous conveying conditions for the granulate it is proposed that the housing (1) forms a discharge chamber (9) which is separate from the feed chamber (8) for the conveying and cooling medium, the rotor (5) which is arranged between the feed chamber (8) and the discharge chamber (9) and which carries the granulator blades (4) is adjacent to the feed chamber (8) with its rear side averted from the granulator blades (4) and is provided within the circular blade arrangement with axial openings (14) for the passage of the conveying and cooling medium from the feed chamber (8) to the discharge chamber (9).

### FIELD OF THE INVENTION

The invention relates to an apparatus for granulating plastic, comprising a granulating head, a die plate for allowing the output of strands of plastic and a rotor which is coaxial to the die plate and comprises granulator blades for cutting strands of plastic exiting from the die plate, and a housing for the granulating head which is connected to a discharge line and a feed line via a feed chamber for a conveying and cooling medium receiving the granulate, preferably a cooling fluid.

### DESCRIPTION OF THE PRIOR ART

For the purpose of granulating plastic materials, a plastic melt is usually pressed in the form of strands of plastic through a die plate which cooperates with a rotor which is coaxial to the die plate and is equipped with granulator blades, so that the strands of plastic which are output to a cooling fluid, preferably water, are cut. The cooling fluid ensures a solidification of the plastic granulate on the one hand and its further conveyance on the other hand. Since the cooling fluid vertically flows through the housing accommodating the granulating head with die plate and rotor while the rotor shaft extends transversally to the direction of flow, there is the likelihood, as a result of gravity, that the granulate will reach the gap between the die plate and the rotor which is enclosed by the blades arranged in a circular way and will remain there, leading to malfunctions in the granulation. Comparable difficulties can also occur with the use of air as a conveying and cooling medium.

Although it is already known (DE 197 20 722 A1) to feed the conveying and cooling medium in an axial manner to the housing which accommodates the rotor, the illustrated difficulties will remain because the conveying and cooling medium is introduced via a coaxial feed chamber into the housing on the side of the rotor which is averted from the granulator blades, so that the conveying and cooling medium is displaced via the rotor radially to the outside and cannot exert any conveying action on the granulate collecting within the circle of blades.

### SUMMARY OF THE INVENTION

The invention is thus based on the object of arranging an apparatus of the kind mentioned above for granulating plastic in such a way that an unobstructed further conveyance of the granulate by the conveying and cooling medium is ensured, and thus an undistorted granulation independent of the installation position of the rotor.

This object is achieved by the invention in such a way that the housing forms a discharge chamber which is separate from the feed chamber for the conveying and cooling medium, the rotor which is arranged between the feed chamber and the discharge chamber and which carries the granulator blades is adjacent to the feed chamber with its rear side averted from the granulator blades and is provided within the circular blade arrangement with axial openings for the passage of the conveying and cooling medium from the feed chamber to the discharge chamber.

Since as a result of these measures the conveying and cooling medium is forced to flow from the feed chamber through the rotor into the gap region between die plate and rotor which is enclosed by the granulator blades, a radially outwardly directed conveying and cooling flow is obtained between the granulator blades, so that the granulate is conveyed in a secure manner from the rotor radially to the outside to the outfeed chamber and from there to the discharge. This arrangement of flow thus ensures a disturbance-free granulation process.

Although the flow connection between the feed chamber of the housing and the rotor plays an only subordinate role for the distribution of flow on the side of the discharge chamber, especially simple constructional conditions are obtained when the rotor comprises a coaxial jacket on the rear side facing the feed chamber, which jacket forms an annular chamber open towards the feed chamber for guiding the conveying and cooling medium, so that the conveying and cooling medium is conveyed with a distinct axial flow component to the rotor. In order to avoid having to provide any sealing of the jacket rotating with the rotor against the feed chamber, the jacket can protrude into the feed chamber with play through an opening of a separating wall perpendicular to the rotor shaft between the feed and the discharge chamber. The play of the jacket of the rotor within the opening of the separating wall between the feed and the discharge chamber not only entails simple constructional conditions, but also causes a flow passage from the feed to the discharge chamber outside of the rotor, leading to the advantage that the otherwise obtained dead flow spaces within the discharge chamber are flushed after the rotor. This flushing prevents the deposit of granulate particles in said dead spaces.

The granulator blades are usually applied with a predetermined pressure against the die plate. Since the gap will decrease between the die plate and the rotor pressurized accordingly in the axial direction in the case of wear and tear of the blades, the flow resistance will increase for the conveying and cooling medium flowing through the rotor, leading to an increased flow of the conveying and cooling medium outside of the rotor in the case of play between the jacket of the rotor and the opening in the separating wall. In order to ensure that actions thus caused on the radial conveyance of granulate from the region of the granulating head are prevented, the jacket can taper conically against the rotor at least in the region of its passage through the opening of the separating wall, so that the flow cross section also formed by the play of the jacket within the opening of the separating wall will decrease with the reduction of the flow cross section in the region of the gap between the die plate and the rotor and accordingly the division of the flow remains the same to a sufficient extent.

### BRIEF DESCRIPTION OF THE DRAWINGS

FIG. 1 shows a schematic longitudinal sectional view of an apparatus according to the invention for granulating plastic;

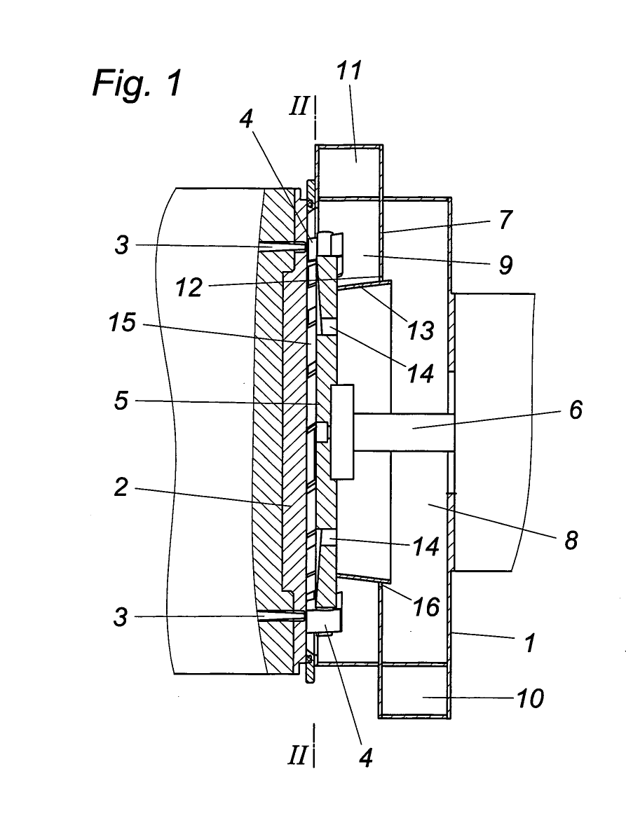

FIG. 2 shows a sectional view along the line II-II in FIG. 1 on a reduced scale.

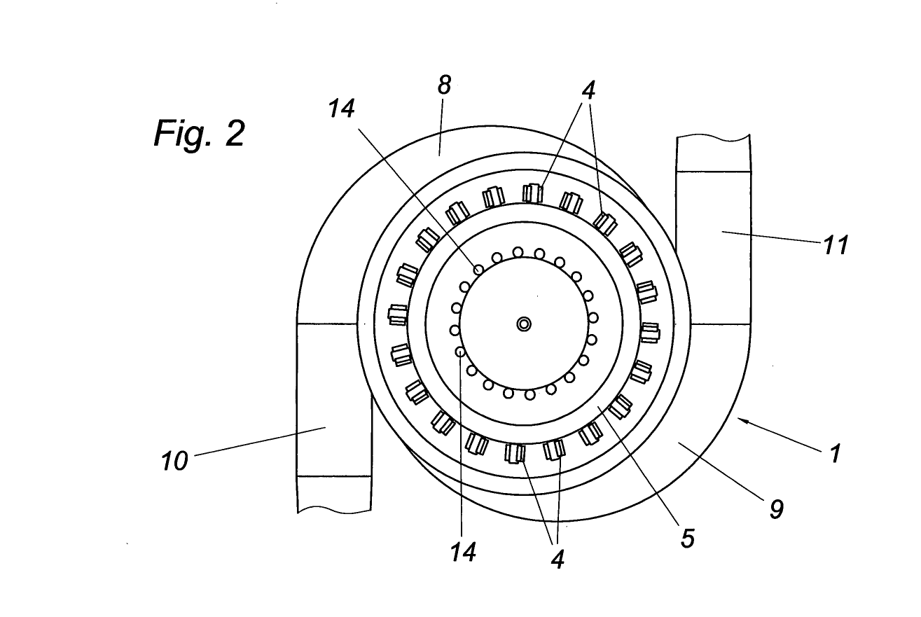

### DESCRIPTION OF THE PREFERRED EMBODIMENTS

The illustrated apparatus comprises a housing 1 which is sealed on one face side by a die plate 2, with outlet nozzles 3 opening into its region through which a plastic melt will exit in a respective number of strands. The strands of plastic exiting in the region of each outlet nozzle 3 are cut with the help of granulator knives 4 into a plastic granulate, which knives are arranged on a rotor 5 which is coaxial to the die plate. The drive shaft 6 for the rotor 5 is guided in a conventional manner through the opposite face side of housing 1.

In contrast to conventional apparatuses of this kind, the housing 1 is subdivided by a separating wall 7 perpendicular to the rotor shaft 6 into a feed chamber 8 and a discharge chamber 9. These chambers 8 and 9 are connected to a feed 10 and a discharge 11 for a cooling fluid, usually water. The separating wall 7 forms an opening 12 which is coaxial to the rotor shaft 6 and through which protrudes a jacket 13 with play which is fastened to the rotor 5 and is coaxial to the rotor shaft 6. The rotor 5 protruding into the discharge chamber 9 is thus connected to the feed chamber 8 via the jacket 13 on its rear side averted from the granulator blades 4. Since the rotor 5 comprises axial openings 14 for the flow passage of the cooling fluid from the feed chamber 8 to the discharge chamber 9 within a region which is enclosed by the granulator blades 4 arranged in a circular way, the cooling fluid flows through the rotor 5 into the gap 15 between the die plate 2 and the rotor 5 and from said gap 15 through the individual granulator blades 4 into the discharge chamber 9.

As a result of this principal flow of the cooling fluid, the cut granulate is carried securely radially to the outside from the rotor 5 into the discharge chamber 9. The annular gap 16 obtained by the play of the jacket 13 within the opening 12 in the separating wall 7 leads to a secondary flow for the cooling fluid that encloses the rotor 5 with the advantage that it is not only possible to omit a sealing of the rotating jacket 13 relative to the separating wall 7, but the discharge chamber 9 is flushed in regions which in their capacity as dead flow spaces tend to accumulate granulate particles. In order to achieve advantageous flow conditions for the cooling fluid within the feed and discharge chamber 8, 9 concerning the cooling water supply to the rotor 5 and the cooling water discharge from rotor 5, these chambers 8, 9 form spirally tapering or expanding guide ducts for the cooling fluid, especially for the feed chamber 8. This is not mandatory however.

The rotor 5 is usually axially pressurized for applying the blades. This axial pressurization of the rotor can at least be supported via the conveying pressure of the incoming cooling fluid as a result of the arrangement of the rotor 5 between the feed and discharge chamber 8, 9. As a result of the wear and tear of the blades and the resulting automatic readjustment of the blades through the axial rotor pressurization, the gap 15 between the die plate 2 and rotor 5 will decrease. In order to ensure that the resulting increased flow resistance will not lead to a displacement of the flow division between the principal flow through the rotor 5 and the secondary flow through the annular gap 16 outside of the rotor 5, the jacket 13 is arranged in a conical way at least in the region of the opening 12 in the separating wall 7, in the manner of a tapering towards the rotor 5, so that in the case of an axial displacement of the rotor 5 against the die plate 2 not only the gap 15 between the die plate 2 and the rotor 5 will be decreased but also the annular gap 16 between the jacket 13 and the opening 12 in the separating wall 7 with the consequence that the flow division will remain approximately the same.

As is shown directly in the drawing, the described effects can also be achieved by a gaseous conveying and cooling medium which flows within the ring of blades through the blade head. Although especially advantageous flow and cooling conditions are obtained with a cooling fluid, the invention can also be used with a gaseous conveying and cooling medium.

1. An apparatus for granulating plastic, comprising a granulating head having a die plate for allowing the output of strands of plastic and a rotor which is coaxial to the die plate and comprises granulator blades for cutting strands of plastic exiting from the die plate, and a housing for the granulating head which is connected to a discharge line and a feed line via a teed chamber for a conveying and cooling medium receiving the granulate, preferably a cooling fluid, wherein the housing (1) forms a discharge chamber (9) which is separate from the feed chamber (8) for the conveying and cooling medium, the rotor (5) which is arranged between the feed chamber (8) and the discharge chamber (9) and which carries the granulator blades (4) is adjacent to the feed chamber (8) with its rear side averted from the granulator blades (5) and is provided within the circular blade arrangement with axial openings (14) for the passage of the conveying and cooling medium from the feed chamber (8) to the discharge chamber (9).

2. An apparatus according to claim 1, wherein the rotor (5) comprises a coaxial jacket (13) on the rear side facing the feed chamber (4), which jacket forms an annular chamber open towards the feed chamber (8) for guiding the conveying and cooling medium.

3. An apparatus according to claim 2, wherein the jacket (13) protrudes into the feed chamber (8) with play through an opening (12) of a separating wall (7) perpendicular to the rotor shaft (6) between the feed and the discharge chamber (8, 9).

4. An apparatus according to claim 3, wherein the jacket (13) tapers conically towards the rotor (5) at least in the region of its passage through the opening (12) of the separating wall (7).
